(19) United States
(12) Patent Application Publication
(10) Pub. No.: US 2009/0175232 A1
(43) Pub. Date: Jul. 9, 2009

(54) Joint Coding of Multiple TTI Information and Quality Indication Requests

(75) Inventor: Troels E. Kolding, Klarup (DK)

Correspondence Address: HARRINGTON & SMITH, PC, 4 RESEARCH DRIVE, Suite 202, SHELTON, CT, 06484-6212, US

(73) Assignee: Nokia Siemens Networks Oy

(21) Appl. No.: 12/349,607

(22) Filed: Jan. 7, 2009

Related U.S. Application Data
(60) Provisional application No. 61/010,451, filed on Jan. 8, 2008.

(51) Int. Cl. H04W 72/04

(52) U.S. Cl. 370/329

(57) ABSTRACT

A method includes storing in a memory a mapping of bit sequences to uplink resources, wherein a first one of the bit sequences indicates an uplink resource and requests a measurement report and a second one of the bit sequences indicates at least two uplink resources; assembling a selected one of the bit sequences with a resource allocation to be sent in a subframe that comprises more uplink resources than downlink resources; and receiving a response to the resource allocation in the uplink resource to which the selected bit sequence maps. In particular embodiments, the bit sequences are either 2 or 3 bits; one maps to a next available uplink resource and another maps to a second next available uplink resource. Apparatus and software are also described for both a network element and a user equipment.

### CROSS REFERENCE TO RELATED APPLICATION

This patent application claims priority under 35 U.S.C. §119(e) from U.S. Provisional Patent Application No.: 61/010,451, filed Jan. 8, 2008, which is incorporated by reference herein in its entirety.

### TECHNICAL FIELD

The exemplary and non-limiting embodiments of this invention relate generally to wireless communications systems and, more specifically, relate to resource allocations to users of the wireless system that continue for more than a single uplink resource, sometimes referred to as multiple transmission time interval allocations.

### BACKGROUND

The following abbreviations are used in the description below:
3GPP third generation partnership project
ACK/NACK acknowledgement/negative acknowledgement
CQI channel quality indicator
DL downlink
e-NodeB Node B of an E-UTRAN system
E-UTRAN evolved UTRAN
H-ARQ hybrid automatic repeat request
LTE long term evolution of 3GPP
Node B base station or similar network access node, including e-NodeB
PDCCH physical downlink control channel
PHICH physical H-ARQ indicator channel
PRB physical resource block
PUSCH physical uplink shared channel
TDD time division duplex
TTI transmission time interval (e.g., 1 ms with new harmonized frame structure in LTE)
UE user equipment (e.g., mobile equipment/station)
UL uplink
UMTS universal mobile telecommunications system
UTRAN UMTS terrestrial radio access network

3GPP is standardizing the long-term evolution (LTE) of the radio-access technology which aims to achieve reduced latency, higher user data rates, improved system capacity and coverage, and reduced cost for the operator. As with any fundamental re-design of a wireless protocol, changing one aspect as compared to an earlier generation system leads to redesign of other portions of the system in order to maximize the advantages to be gained. Specifically, LTE employs the concept of the e-NodeB scheduling its own radio resources within the cell, which gives more flexibility to put available resources to use and also reduces latency in addressing uplink and downlink needs of the various user equipments in the cell. Its most flexible form is dynamic scheduling, where a single scheduling grant sent on a shared control channel grants to one particular user equipment one particular amount of physical resources in the downlink and/or the uplink. For an uplink scheduling grant, this amount of physical resources is constructed of a number of uplink physical resource blocks which are frequency domain resources within a single subframe interval (1 millisecond in LTE). The time and frequency domain transmission resources covered by a scheduling grant is denoted the transmission time interval TTI. The Node B (or its surrogate in the case of relay stations) then must send an ACK or NACK as appropriate to the user equipment once that granted set of UL PRBs passes so the UE can know whether or not it must re-transmit its UL data. LTE sends the ACK/NACK on a special channel (PHICH) when adaptive HARQ is conducted. For non-adaptive HARQ, no explicit ACK/NACK is transmitted but a retransmission is always requested using a new scheduling grant that contains signaling to identify it as a retransmission. The ACK/NACK on the PHICH is made compatible with dynamic scheduling by mapping the UL resource which is granted to the UE to the particular PHICH where the ACK/NACK is to be, and the development of LTE has seen various proposals for specifics of that mapping. LTE uses a HARQ arrangement for ACK/NACK signaling. The exact mapping regimen of PHICH to PDCCH grant/PRB has not yet been settled upon.

The scheduling flexibility in LTE results in the case where there may be an imbalance in a frame between the number of downlink PDCCHs on which the scheduling grants are sent and the number of uplink TTIs that are scheduled by those PDCCHs. Since in the LTE TDD mode (with the recently adopted harmonized frame structure) there can be two subframes configured for downlink (including the special subframe) and simultaneously three subframes configured for uplink, there is a need for considering this special case when there are more uplink resources than downlink resources in a frame. As the exact allocations for TDD are not agreed, the specific non-limiting examples presented herein address the case of three uplink subframes and two downlink subframes in the (harmonized LTE) frame. The general idea of multi-TTI scheduling in uplink is that a single UL grant on the PDCCH may allocate multiple consecutive UL TTIs to single users at one time. In the case where we have more uplink resources than downlink resources where the PDCCHs is transmitted in TDD, the scheduling of multiple uplink TTIs to the same user becomes a common scenario and thus multi-TTI uplink scheduling is an important feature for reducing the PDCCH signaling overhead. Multi-TTI is a default assumption in 3GPP although its exact implementation is not yet determined.

For multi-TTI uplink grants it is very attractive that the ACK/NACK mapping is determined by the allocated physical resources as this applies to the full multi-TTI allocation and thus no “memory” is induced related to earlier multi-TTI allocations on the PDCCH when extracting the proper location for the ACK/NACK related to a given UL subframe. Further, with the proposed compression methods, this framework allows for a better tradeoff among scheduling flexibility in uplink and multi-TTI scheduling ability in TDD. However, these teachings address both aspects: mapping PHICH to PRB and mapping PHICH to allocation order.

To ensure a multi-TTI concept with significant PDCCH saving, it is needed to have a multi-TTI duration that is at least 2 or 3 UL subframes long (where 2 is absolute minimum for obvious reasons). Signaling a multi-TTI window of up to 3 UL subframes requires up to 3 bits for maximum flexibility. LTE uses dynamic scheduling so these three bits would be frequently repeated and represent fixed control signaling overhead on the PDCCH.

Also in the development of LTE it has been agreed that the e-NodeB will have the capacity to request the UE to send on a PUSCH a CQI report, and that request may also be sent on the PDCCH. The e-NodeB sets what is termed a scheduling bit on the PDCCH, which the UE recognizes and responds with its CQI report, though the exact implementation is not yet decided. The type of CQI report is often referred to as scheduled CQI.

Throughout the development of LTE and other wireless systems, efficient use of control signaling bits is advantageous to save bandwidth.

### SUMMARY

In accordance with one exemplary embodiment of the invention there is a method comprising storing in a memory a mapping of bit sequences to uplink resources, wherein a first one of the bit sequences indicates an uplink resource and requests a measurement report and a second one of the bit sequences indicates at least two uplink resources; assembling a selected one of the bit sequences with a resource allocation to be sent in a subframe that comprises more uplink resources than downlink resources; and receiving a response to the resource allocation in the uplink resource to which the selected bit sequence maps.

In accordance with another exemplary embodiment of the invention there is an apparatus comprising: a memory storing a mapping of bit sequences to uplink resources, wherein a first one of the bit sequences indicates an uplink resource and requests a measurement report and a second one of the bit sequences indicates at least two uplink resources; a processor configured to assemble a selected one of the bit sequences with a resource allocation to be sent in a subframe that comprises more uplink resources than downlink resources; and a receiver configured to receive a response to the resource allocation in the uplink resource to which the selected bit sequence maps.

In accordance with a further embodiment of the invention there is an apparatus comprising memory means (e.g., a computer readable storage medium) for storing a mapping of bit sequences to uplink resources, in which a first one of the bit sequences indicates an uplink resource and requests a measurement report and a second one of the bit sequences indicates at least two uplink resources. In this embodiment the apparatus further comprises processing means (e.g., one or more digital data processors) for assembling a selected one of the bit sequences with a resource allocation to be sent in a subframe that comprises more uplink resources than downlink resources; and receiving means (e.g., a wireless receiver or transceiver) for receiving a response to the resource allocation in the uplink resource to which the selected bit sequence maps

In accordance with yet another exemplary embodiment of the invention there is a memory storing a program of computer readable instructions. When the stored instructions are executed by a processor, the resulting actions comprise: selecting a bit sequence from a storage medium that stores a mapping of bit sequences to uplink resources, wherein a first one of the bit sequences indicates an uplink resource and requests a measurement report and a second one of the bit sequences indicates at least two uplink resources; and assembling the selected bit sequence with a resource allocation to be sent in a subframe that comprises more uplink resources than downlink resources.

In accordance with a further exemplary embodiment of the invention there is a method comprising: storing in a memory a mapping of bit sequences to uplink resources, wherein a first one of the bit sequences indicates an uplink resource and requests a measurement report and a second one of the bit sequences indicates at least two uplink resources; receiving, in a subframe that comprises more uplink resources than downlink resources, a selected one of the bit sequences with a resource allocation; determining from the memory the uplink resource or resources that map to the received bit sequence; and assembling uplink data and a measurement report in the determined uplink resource for the case that the determined bit sequence is the first bit sequence, or assembling uplink data without a measurement report in the determined at least two uplink resources for the case that the determined bit sequence is the second bit sequence.

In accordance with a still further exemplary embodiment of the invention there is an apparatus comprising: a memory storing a mapping of bit sequences to uplink resources, wherein a first one of the bit sequences indicates an uplink resource and requests a measurement report and a second one of the bit sequences indicates at least two uplink resources; a receiver configured to receive, in a subframe that comprises more uplink resources than downlink resources, a selected one of the bit sequences with a resource allocation; and a processor configured to determine from the memory the uplink resource or resources that map to the received bit sequence, and to assemble data and a measurement report in the determined uplink resource for the case that the determined bit sequence is the first bit sequence, or to assemble data without a measurement report in the determined at least two uplink resources for the case that the determined bit sequence is the second bit sequence.

In accordance with yet a further exemplary embodiment of the invention there is an apparatus comprising: memory means (e.g., a computer readable storage medium) for storing a mapping of bit sequences to uplink resources, in which a first one of the bit sequences indicates an uplink resource and requests a measurement report and a second one of the bit sequences indicates at least two uplink resources. In this embodiment the apparatus further comprises receiving means (e.g., a wireless receiver or transceiver) for receiving, in a subframe that comprises more uplink resources than downlink resources, a selected one of the bit sequences with a resource allocation. This exemplary apparatus also comprises processing means (e.g., one or more digital data processors) for determining from the memory means the uplink resource or resources that map to the received bit sequence, and for assembling data and a measurement report in the determined uplink resource for the case that the determined bit sequence is the first bit sequence, or for assembling data without a measurement report in the determined at least two uplink resources for the case that the determined bit sequence is the second bit sequence

### BRIEF DESCRIPTION OF THE DRAWINGS

The foregoing and other aspects of these teachings are made more evident in the following Detailed Description, when read in conjunction with the attached Drawing Figures.

FIG. 1A shows a simplified block diagram of various electronic devices that are suitable for use in practicing the exemplary embodiments of this invention.

FIG. 1B is a more detailed schematic diagram of a user equipment shown at FIG. 1A.

FIG. 2 is a schematic transmission diagram illustrating one particular embodiment in which joint control signaling is used to code for up to two TTIs and to request a CQI.

FIG. 3A is a schematic transmission diagram illustrating one particular embodiment in which joint control signaling is used to code with two bits for up to three TTIs and to request a CQI.

FIG. 3B is similar to FIG. 3A but using a different two-bit coding scheme that gives greater flexibility to schedule individual TTIs but less flexibility to schedule multi-TTI combinations.

FIG. 3C is similar to FIG. 3A but using three bits to code with greater flexibility for single and multi-TTI allocations.

FIG. 3D is similar to FIG. 3A but using a different two-bit coding scheme that combines advantages of FIGS. 3A and 3B but does not code for a CQI report.

FIGS. 4A-4B are process flow diagrams that illustrate operations of a method, a computer program, and an apparatus according to exemplary embodiments of the invention from the perspective of the UE and the e-Node B, respectively.

### DETAILED DESCRIPTION

Embodiments of this invention relate to joint signaling of multi-TTI information and a scheduled CQI request. The same control signaling bits select between single or multi-TTI and are also used to request the allocated UE to send a CQI report. As will be seen, in an exemplary embodiment there are up to three TTI allocations including scheduled CQI signaled by just 2 bits, whereas up to 4 bits would be needed with a default bitmap and scheduled CQI bit methods. There is also detailed an exemplary timing relation so that there is no ambiguity in interpretation of the multi-TTI/scheduled CQI information as would also require separate signaling without the invention. Various embodiments offer full scheduling flexibility, and significantly compress PDCCH overhead via use of multi-TTI UL grants, and offers almost full flexibility in requesting multi-TTI scheduling as well as scheduled CQI. Whereas the examples presented herein are in the specific context of LTE, these teachings are equally applicable to any wireless system that uses dynamic resource allocation.

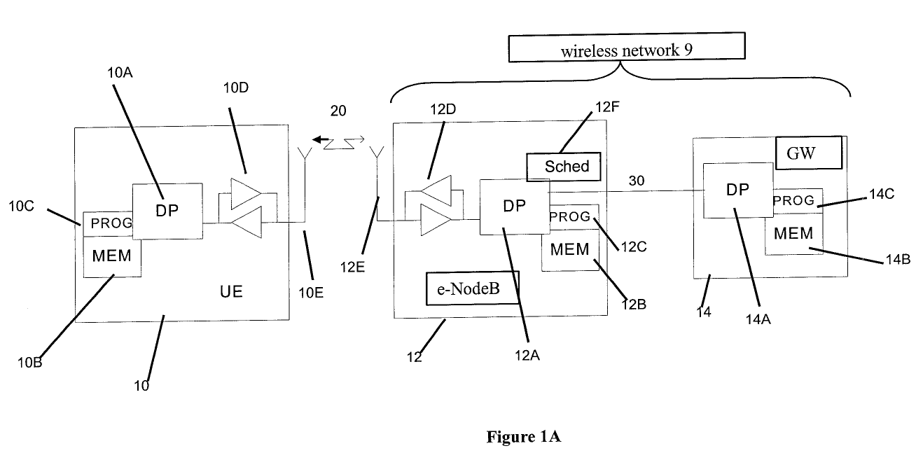

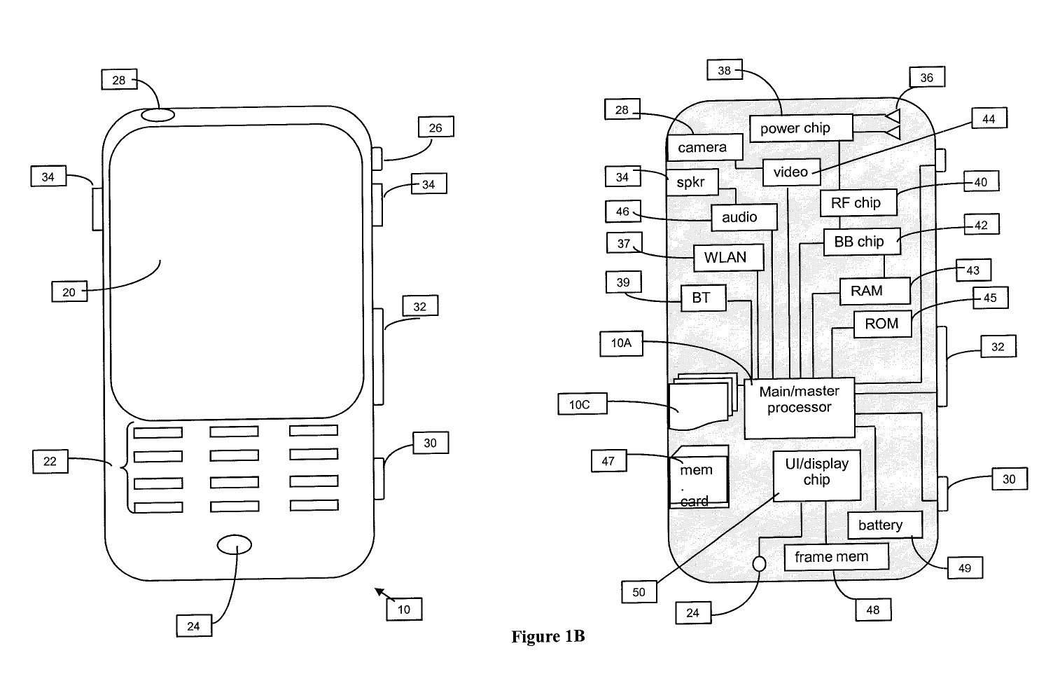

As a preliminary matter before exploring details of various implementations, reference is made to FIG. 1A for illustrating a simplified block diagram of various electronic devices that are suitable for use in practicing the exemplary embodiments of this invention. In FIG. 1A a wireless network 9 is adapted for communication between a UE 10 and a Node B 12 (e.g., a wireless access node, such as a base station or particularly an e-NodeB for a LTE system). The network 9 may include a gateway GW/serving mobility entity MME/radio network controller RNC 14 or other radio controller function known by various terms in different wireless communication systems. The UE 10 includes a data processor (DP) 10A, a memory (MEM) 10B that stores a program (PROG) 10C, and a suitable radio frequency (RF) transceiver 10D coupled to one or more antennas 10E (one shown) for bidirectional wireless communications over one or more wireless links 20 with the Node B 12. The wireless links 20 represent in the particular embodiments described the various channels PDCCH, PHICH and the like. For the case of MU-MIMO, the UEs 10 being allocated on the MU-MIMO basis may have more than one antenna 10E.

The terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and printed electrical connections, as well as by the use of electromagnetic energy, such as electromagnetic energy having wavelengths in the radio frequency region, the microwave region and the optical (both visible and invisible) region, as non-limiting examples.

The e-NodeB 12 also includes a DP 12A, a MEM 12B, that stores a PROG 12C, and a suitable RF transceiver 12D coupled to one or more antennas 12E. The e-NodeB 12 may be coupled via a data path 30 (e.g., lub or Si interface) to the serving or other GW/MME/RNC 14. The GW/MME/RNC 14 includes a DP 14A, a MEM 14B that stores a PROG 14C, and a suitable modem and/or transceiver (not shown) for communication with the Node B 12 over the lub link 30.

Also within the e-NodeB 12 is a scheduler 12F that schedules the various UEs under its control for the various UL and DL radio resources. Once scheduled, the e-NodeB sends messages to the UEs with the scheduling grants (typically multiplexing grants for multiple UEs in one message). These grants are sent over particular channels such as the PDCCH in LTE. Generally, the e-NodeB 12 of an LTE system is fairly autonomous in its scheduling and need not coordinate with the GW/MME 14 excepting during handover of one of its UEs to another Node B.

At least one of the PROGs 10C, 12C and 14C is assumed to include program instructions that, when executed by the associated DP, enable the electronic device to operate in accordance with the exemplary embodiments of this invention, as detailed above. Inherent in the DPs 10A, 12A, and 14A is a clock to enable synchronism among the various apparatus for transmissions and receptions within the appropriate time intervals and subframes required, as the scheduling grants and the granted resources/subframes are time dependent. The transceivers 10D, 12D include both transmitter and receiver, and inherent in each is a modulator/demodulator commonly known as a modem. The DPs 12A, 14A also are assumed to each include a modem to facilitate communication over the (hardwire) link 30 between the e-NodeB 12 and the GW 14.

The PROGs 10C, 12C, 14C may be embodied in software, firmware and/or hardware, as is appropriate. In general, the exemplary embodiments of this invention may be implemented by computer software stored in the MEM 10B and executable by the DP 10A of the UE 10 and similar for the other MEM 12B and DP 12A of the e-NodeB 12, or by hardware, or by a combination of software and/or firmware and hardware in any or all of the devices shown.

In general, the various embodiments of the UE 10 can include, but are not limited to, mobile stations, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

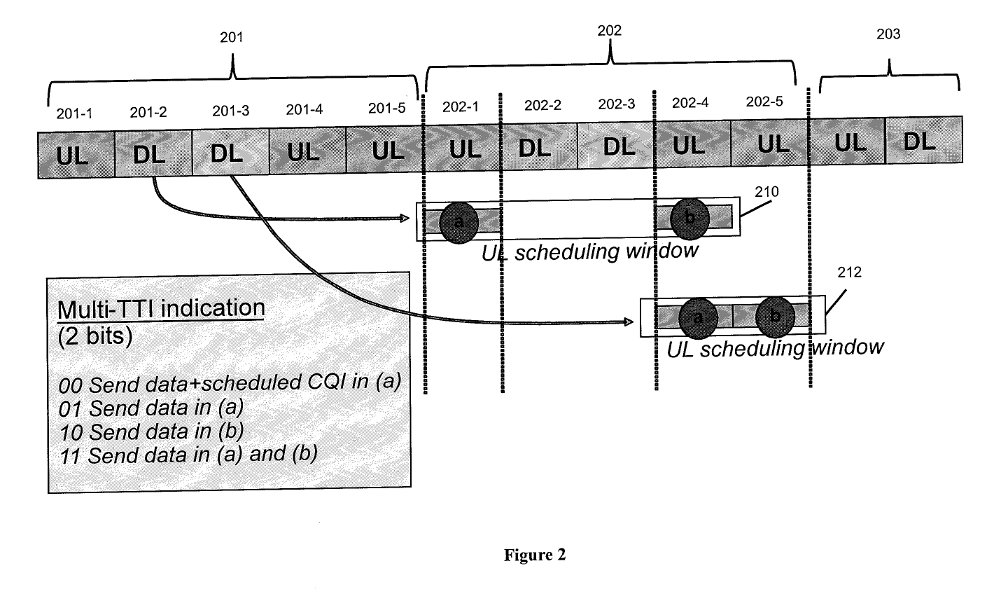

FIG. 1B illustrates further detail of an exemplary UE in both plan view (left) and sectional view (right), and the invention may be embodied in one or some combination of those more function-specific components. At FIG. 2B the UE 10 has a graphical display interface 20 and a user interface 22 illustrated as a keypad but understood as also encompassing touch-screen technology at the graphical display interface 20 and voice-recognition technology received at the microphone 24. A power actuator 26 controls the device being turned on and off by the user. The exemplary UE 10 may have a camera 28 which is shown as being forward facing (e.g., for video calls) but may alternatively or additionally be rearward facing (e.g., for capturing images and video for local storage). The camera 28 is controlled by a shutter actuator 30 and optionally by a zoom actuator 32 which may alternatively function as a volume adjustment for the speaker(s) 34 when the camera 28 is not in an active mode.

Within the sectional view of FIG. 2B are seen multiple transmit/receive antennas 36 that are typically used for cellular communication. The antennas 36 may be multi-band for use with other radios in the UE. The operable ground plane for the antennas 36 is shown by shading as spanning the entire space enclosed by the UE housing though in some embodiments the ground plane may be limited to a smaller area, such as disposed on a printed wiring board on which the power chip 38 is formed. The power chip 38 controls power amplification on the channels being transmitted and/or across the antennas that transmit simultaneously where spatial diversity is used, and amplifies the received signals. The power chip 38 outputs the amplified received signal to the radio-frequency (RF) chip 40 which demodulates and downconverts the signal for baseband processing. The baseband (BB) chip 42 detects the signal which is then converted to a bit-stream and finally decoded. Similar processing occurs in reverse for signals generated in the apparatus 10 and transmitted from it.

Signals to and from the camera 28 pass through an image/video processor 44 which encodes and decodes the various image frames. A separate audio processor 46 may also be present controlling signals to and from the speakers 34 and the microphone 24. The graphical display interface 20 is refreshed from a frame memory 48 as controlled by a user interface chip 50 which may process signals to and from the display interface 20 and/or additionally process user inputs from the keypad 22 and elsewhere.

Certain embodiments of the UE 10 may also include one or more secondary radios such as a wireless local area network radio WLAN 37 and a Bluetooth® radio 39, which may incorporate an antenna on-chip or be coupled to an off-chip antenna. Throughout the apparatus are various memories such as random access memory RAM 43, read only memory ROM 45, and in some embodiments removable memory such as the illustrated memory card 47 on which the various programs 10C are stored. All of these components within the UE 10 are normally powered by a portable power supply such as a battery 49.

The aforesaid processors 38, 40, 42, 44, 46, 50, if embodied as separate entities in a UE 10 or e-Node B 12, may operate in a slave relationship to the main processor 10A, 12A, which may then be in a master relationship to them. Certain embodiments of this invention may be disposed in the baseband chip 42, though it is noted that other embodiments need not be disposed there but may be disposed across various chips and memories as shown or disposed within another processor that combines some of the functions described above for FIG. 2B. Any or all of these various processors of FIG. 2B access one or more of the various memories, which may be on-chip with the processor or separate therefrom. Similar function-specific components that are directed toward communications over a network broader than a piconet (e.g., components 36, 38, 40, 42-45 and 47) may also be disposed in exemplary embodiments of the access node 12, which may have an array of tower-mounted antennas rather than the two shown at FIG. 2B.

Note that the various chips (e.g., 38, 40, 42, etc.) that were described above may be combined into a fewer number than described and, in a most compact case, may all be embodied physically within a single chip.

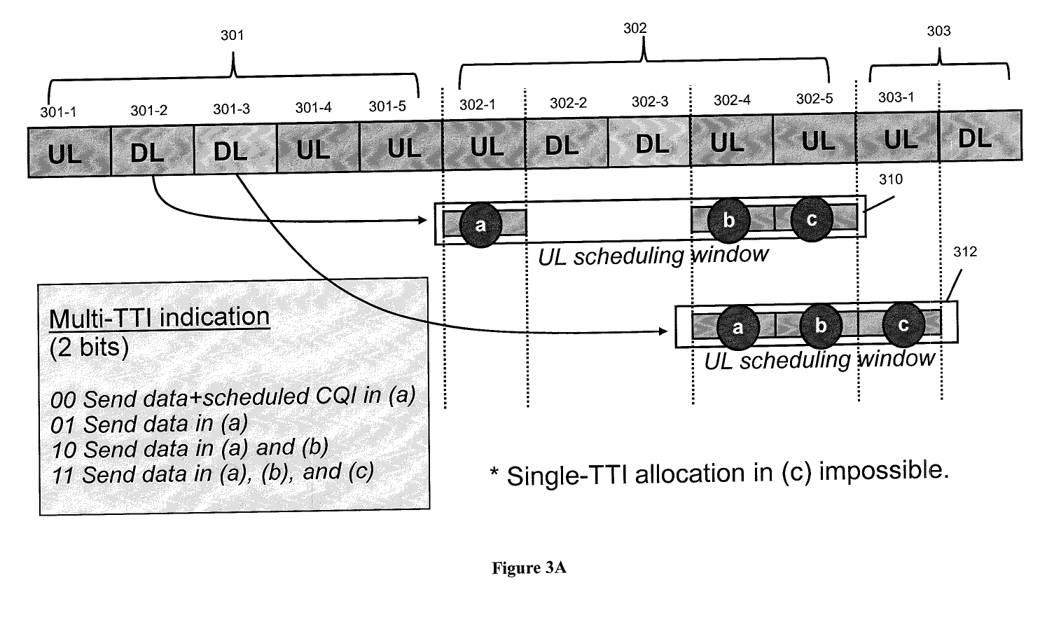

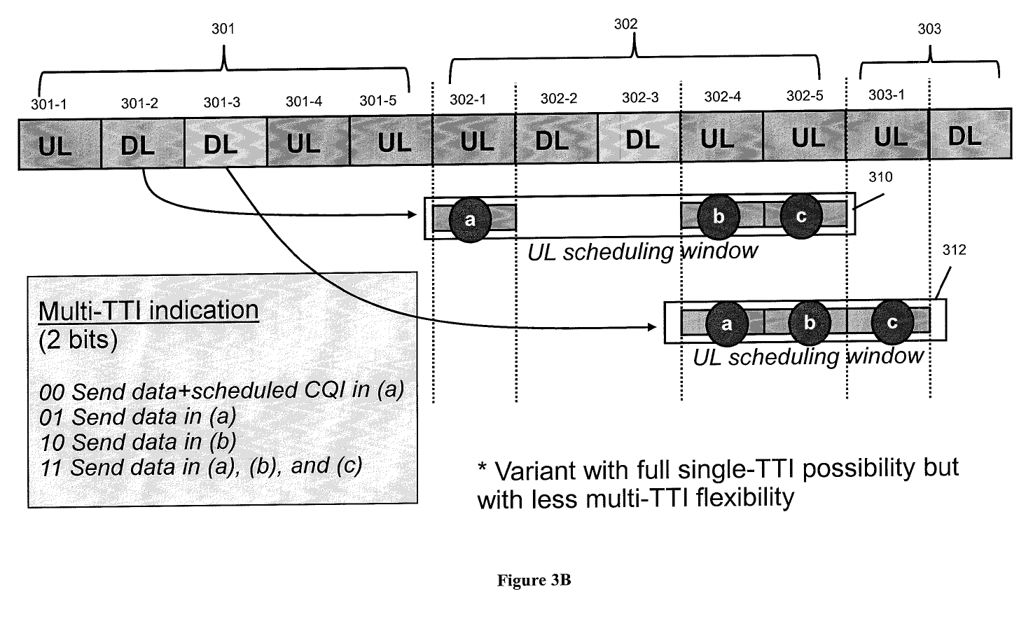

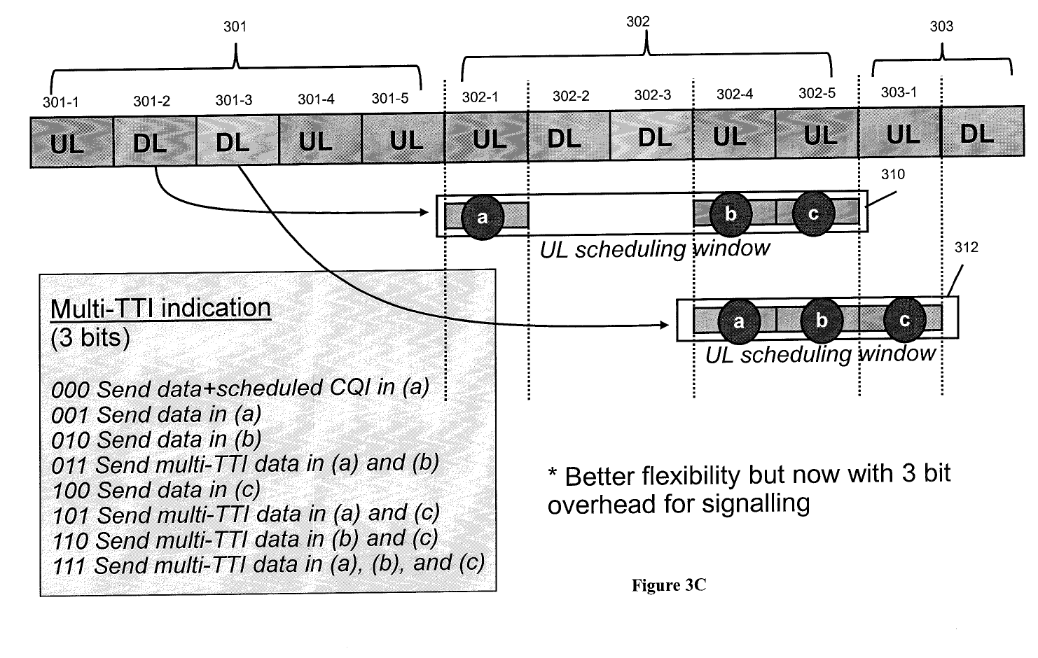

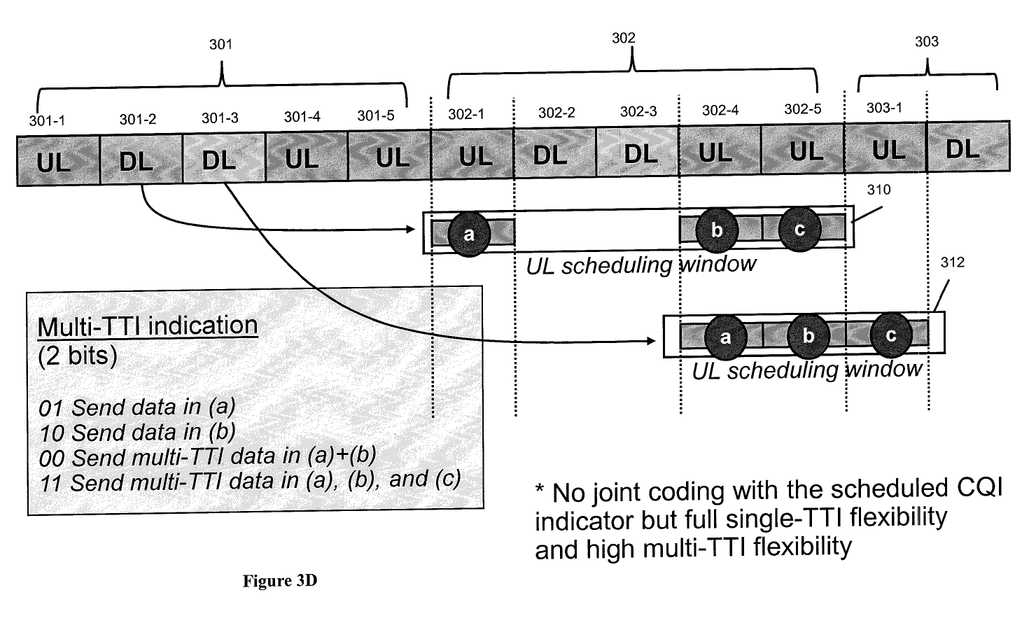

Now are described particular embodiments of the invention in detail. Two specific exemplary but non-limiting embodiments are shown by the Figures: one where the multi-TTI indication means 2 TTIs (FIG. 2) and the other where the multi-TTI indication means 3 TTIs (FIGS. 3A-3D). Both may be relevant for 3GPP standardization depending on what is decided related to the ACK/NACK mapping for the PHICH channel. If it depends on the PDCCH, then the 2 TTI option may be more attractive whereas if the mapping relies on the allocated UL PRBs then the 3TTI option becomes more attractive. While being illustrated for 2-TTI and 3-TTI options, the control signaling presented herein by example can readily be adapted for longer multi-TTI windows. Each of these examples assume the recently adopted harmonized frame structure, and for the case where there are more UL resources in a subframe than DL resources.

Specifically, the first TTI is UL, the next two are DL over which the PDCCH is sent, and the remaining three TTIs are UL. For simplicity of explanation, the same subframe arrangement is repeated in the examples though these teachings apply equally when one subframe exhibits a relative arrangement and/or ratio of DL and UL that differs from that of an adjacent subframe. For ease of description, consider the term ‘scheduling window” as that set of consecutive UL TTIs which potentially may be allocated by a single DL PDCCH, depending on the value of the multi-TTI indicator bits detailed herein. Depending on the location of the first UL TTI in that window, the window may or may not extend into the next subframe as will be seen. UL TTIs are consecutive if there are no other UL TTIs between them; as will be seen there may be one or more intervening DL TTIs without disrupting consecutive UL TTIs.

First consider FIG. 2, an example wherein the multi-TTI is a maximum of 2 TTIs. The TTI scheduling window is then 2 TTIs. FIG. 2 illustrates two full subframes 201, 202 and the beginning of a third subframe 203. Within the first subframe is a leading UL slot/TTI 201-1, followed by two consecutive DL slots/TTIs 201-2, 201-3, followed by two consecutive UL slots/TTIs 201-4, 201-5. Slots/TTIs 202-1 through 202-5 of the second subframe 202 are similarly numbered. Assume that each DL TTI (e.g. the PDCCH which is assumed present in both a normal and special time subframes in downlink) can address two TTIs with a single-TTI allocation (e.g. double booking of the first UL subframe in each group of 3 UL subframes in FIG. 2).

An example of joint coding of scheduled CQI and multi-TTI allocations is indicated in the text box of FIG. 2. Specifically, the 2 bit solution shown there by example is interpreted as follows, recognizing that this is only an example and the meaning attributed to these bit combinations may be reversed or re-ordered as compared to this example:
00: This bit sequence represents a request for the UE to send data in the UL subframe denoted by (a) in FIG. 2. Note that the location of (a) changes depending on which PDCCH that contains the signaling bits for multi-TTI and scheduled CQI. If the e-Node B sends these two signaling bits in the first DL slot/TTI 201-2 of the first subframe 201, the UE interprets this to mean it should send its CQI (plus scheduled data) in the first UL slot/TTI of the next subframe 202, reference number 202-1. If instead the e-Node B sends these two signaling bits in the second DL slot/TTI 201-3 of the first subframe 201, the UE interprets this to mean it should send its CQI (plus scheduled data) in the UL slot/TTI 202-4 of the next subframe that follows the DL slots/TTIs 202-2 and 202-3. In both cases, the UE sends its CQI in the next available UL slot/TTI after which the signaling bit sequence 00 is received (taking into account processing delays as currently formulated in LTE). Sequence 00 also means that the e-Node B requests the UE to send its CQI together with the data packet as has been agreed for LTE FDD and TDD.
01: This bit sequence represents a normal single-TTI UL grant that relates to the first possible UL subframe available for scheduling (taking into account processing delays). No request for scheduled CQI is included so this is the normal grant. The UE interprets this bit sequence 01 to mean it is authorized to send its data, but that the e-Node B is not requesting its CQI report. The data is also sent in the slots/TTIs designated (a) depending on which DL slot/TTI 201-2 or 201-3 that bit sequence was received as detailed immediately above, but without CQI.
10: This bit sequence is a single-TTI UL grant for the second possible UL subframe that is available, denoted as (b) in FIG. 2. This is also needed for normal operation when the number of UL TTIs exceed the number of DL TTIs in a subframe. For the case where the e-Node B sends this bit sequence 10 in the first DL slot/TTI 201-2 of the first subframe 201, the UE interprets this to mean it should send its data (without CQI) in the second available UL slot/TTI, which is reference number 202-4 and which lies within the next subframe 202. For the case where the e-Node B sends this bit sequence 10 in the second DL slot/TTI 201-3 of the first subframe 201, the second available UL slot/TTI is reference number 202-5 and which also lies within the next subframe 202. In both cases for this signaling bit sequence 01, the UE sends its CQI in the second available UL slot/TTI after which the signaling bit sequence is received (taking into account processing delays as currently formulated in LTE).
11: This bit sequence is a 2-TTI allocation across both (a) and (b) TTIs of FIG. 2. As is the general assumption in 3GPP, the allocated physical resources are the same and thus transmission parameters will be the same for both transmission in (a) and (b) when allocated by multi-TTI techniques, such as the multi-TTI indicator bits denoted here. Whether the e-Node B sends this bit sequence 11 in the first DL slot/TTI 201-2 or the second DL slot/TTI 201-3 of the first subframe 201, the UE interprets it to mean it is authorized to send its data (without CQI) in each of the next two available UL slots/TTIs. So where the bit sequence 11 is sent in the first DL slot/TTI 201-2 of the first subframe 201, the UE sends its data in the first 202-1 and second 202-4 UL slots/TTIs of the next subframe 202. For the case where the bit sequence 11 is sent in the second DL slot/TTI 201-3 of the first subframe 201, the UE sends its data in the second 202-4 and third 202-5 UL slots/TTIs of the next subframe 202.

Where the allocation and the multi-TTI indicator bits are sent in the first DL 201-2 of FIG. 2, the allocated UL resources are in the scheduling window 210 that spans the next pair of DL TTIs 202-2, 202-3 and so the two consecutive UL TTIs 202-1 and 202-4 being allocated by the bit sequence “11” are not adjacent to one another. Where that same bit sequence “11” is sent in the second DL TTI 201-3, the scheduling window 212 is as shown toward the bottom of FIG. 2 and the two UL TTIs 202-4 and 202-5 are consecutive and also adjacent. In either case, if the bit sequence were “00” the UE would know it is allocated only the UL TTI designated (a) [either 202-1 or 202-4, depending on which DL TTI 201-2 or 202-3 in which that sequence was received] and that it is further to send a CQI report on the UL PUSCH (a) that it was just allocated. The two remaining bit sequences “01” and “10” allocate a single UL TTI and do not code for the CQI report.

Note that separate single-TTI allocation in both (a) and (b) is still possible by the normal scheduling means (PDCCH) in the TDD mode. There are some good advantages of the method and some minor disadvantages. On the advantage side, single-TTI UL grants can be evenly split between all the DL subframes. The disadvantages are fairly minor. Scheduled CQI can only be requested in the first and third UL subframes 202-1 and 202-4 in each group of 3 UL subframes, but this is seen to be a minor issue and not all users are requested to send CQI every 5-ms period so that the load could be distributed. Instead the 2^{nd} subframe could be used in an embodiment for periodic CQI reporting which is also expected to be widely used in LTE TDD. Also, the above exemplary embodiments do 2-TTI allocation over 2 out of 3 of the total combinations, but this is assumed to be sufficient and also allows room for retransmission and single-TTI allocations which are needed for many users anyway. A significant advantage is that this joint coding reduces the signaling overhead cost from 3 bits to 2 bits.

As noted above, there is also an embodiments which uses a slightly longer window of 3 TTIs. The reason is that each group of 3 TTIs can then be covered with a single UL grant thereby providing significant savings in signaling overhead over the 2-TTI window where at least 2 UL grants are then needed per 5-ms allocation period. Reference numbers for the slots/TTIs of FIGS. 3A-3C are similar to those used for FIG. 2. Within the first subframe 301 there is a leading UL slot/TTI 301-1, followed by two adjacent and consecutive DL slots/TTIs 301-2, 301-3, followed by two more UL slots/TTIs 301-4, 301-5. The second subframe 302 also has a first slot/TTI 302-1 that is UL, second 302-2 and third 302-3 slots/TTIs that are DL, and fourth 302-4 and fifth 302-5 slots/TTIs that are UL. The third subframe 302 leads with a first UL slot/TTI 303-1.

The overall concept is similar to that of FIG. 2 and is shown by example at FIG. 3A. The UL scheduling window for this embodiment also changes depending on which DL PDCCH the multi-TTI bits are sent; if sent in the first DL TTI the scheduling window 310 is as shown nearer the top of FIG. 3A and if sent in the second DL TTI the scheduling window 312 is as shown nearer the bottom of FIG. 3A. The two-bit multi-TTI indicator bits are interpreted (by non-limiting example) as shown in the text box of FIG. 3A.

Specifically for the exemplary but non-limiting meaning assigned to the two-bit sequence shown at FIG. 3A, if the bit sequence 00 is present in the first DL slot/TTI 301-2 of the first subframe 301, the UE interprets it to mean it should send its data plus CQI in the next available UL slot/TTI, which is the first slot/TTI 302-1 of the next subframe 302 in FIG. 3A. If instead the bit sequence 00 is present in the second DL slot/TTI 301-3 of the first subframe 301, the UE interprets it to mean it should send its data plus CQI in the second available UL slot/TTI, which is the fourth slot 302-4 of the next subframe 302 in FIG. 3A. Both of these are designated (a) in the different scheduling windows 310, 312. Bit sequence 01 is interpreted for FIG. 3A the same as was detailed for FIG. 2.

The 3-TTI option of FIG. 3A differs from FIG. 2 in two respects as follows. First, bit sequence 10 is interpreted for FIG. 3A for the UE to send its data (without CQI) in the UL slot/TTI designated (b) in FIG. 3A, which is the second available UL subframe after the bit sequence 10 is received (slot/TTI 302-4 is the e-Node B sent the sequence in the second slot/TTI 301-2 of the first subframe, and slot/TTI 302-5 if the e-Node B sent the sequence in the third slot/TTI 301-3 of the first subframe 301).

Second, if the bit sequence 11 is present in the first DL slot/TTI 301-2 of the first subframe 301, the UE interprets it to mean it should send its data (without CQI) in the next three available UL slot/TTI, which is the first slot/TTI 302-1 of the next subframe 302 in FIG. 3A as well as the fourth slot/TTI 302-4 and the fifth slot/TTI 302-5. If instead the bit sequence 11 is present in the second DL slot/TTI 301-3 of the first subframe 301, the UE interprets it to mean it should send its data (without CQI) in the second available UL slot/TTI and the next two consecutive UL slots/TTIs, which is the fourth 302-4 and fifth slots/TTIs of the next subframe 302 plus the first slot/TTI 303-1 of the following (third) subframe 303 in FIG. 3A. In this latter case the scheduling window spans both the second and third subframes 302, 303.

As can be seen from FIG. 3A, one, two or three consecutive TTIs can be scheduled in a single DL PDCCH using those two bits, and also there is an option for scheduling one TTI with a joint request for the scheduled UE to send its CQI report on that scheduled UL TTI. As with the discussion above for FIG. 2, there are certain advantages and disadvantages. Specifically, single-TTI allocations can be evenly distributed over the DL subframes for improved scheduling flexibility in the downlink. There are 2-TTI allocations that can be made in 2-out-of-3 of the possibilities. There are also 3-TTI allocations that can made in 2-out-of-3 of the possibilities, and these are sufficient for the same reason noted above at FIG. 2. This is because the different UL TTIs can be selected just by selecting which PDCCH carries the multi-TTI indicator bits. Scheduled CQI can be offered in 2 out of 3 UL subframes. This is sufficient and the remaining subframe can be used for periodic reporting if some reporting overhead should be transferred here. By joint coding the signaling overhead is reduced from the worst-case 5 bits to just 2 bits (or at least from 4 bits if we introduce direction of assignment type reporting).

FIG. 3B is a slightly different implementation than FIG. 3A, using a different bit allocation scheme. At FIG. 3B, there are more single-TTI allocations possible because bit sequence “01” now informs the UE that the UL allocation is for the TTI denoted in FIG. 3B as (b), but does not also inform the UE to send its CQI report. In FIG. 3B, for the case that the e-Node B sends the bit sequence 01 in the first DL slot/TTI 301-2 (the second overall TTI) or the second DL slot/TTI 301-3 (the third slot/TTI overall) of the first subframe 301, the UE interprets it to mean it should send its data (without CQI) as detailed with respect to FIG. 2. For the case where the e-Node B sends the bit sequence 11 in the first DL slot/TTI 301-2 (the second overall TTI) or the second DL slot/TTI 301-3 (the third slot/TTI overall) of the first subframe 301, the UE interprets it to mean it should send its data (without CQI) as detailed with respect to FIG. 3A. This selection enables any of the UL TTIs to be scheduled as a single UL TTI, but foregoes the option of a 2-TTI multi-allocation; all allocations in FIG. 3B are either single TTI or triple consecutive TTIs.

Another variation is shown at FIG. 3C, where the multi-TTI indicator bits are expanded to a three-bit sequence with the (arbitrarily assigned) meaning shown in the text box. With the additional third signaling bit there are many more options for single, dual or triple TTI scheduling, but of course the cost is an additional signaling bit in each PDCCH.

Specifically, at FIG. 3C the bit sequence 000 is interpreted by the UE the same as the bit sequence 00 was described for FIG. 2, and the bit sequence 001 is interpreted the same except that CQI is not sent with the data. Bit sequence 010 is interpreted for FIG. 3C the same as bit sequence 10 was detailed with respect to FIGS. 2 and 3B. Bit sequence 011 is interpreted for FIG. 3C the same as bit sequence 10 was detailed with respect to FIG. 3B. Bit sequence 111 for FIG. 3C is interpreted for FIG. 3C the same as bit sequence 11 was detailed with respect to FIGS. 3A and 3B.

For FIG. 3C, bit sequences 100, 101, and 110 have new meanings not before detailed. Bit sequence 100 is interpreted that the UE should send its data without CQI in designated slot/TTI (c), which is the third available UL slot/TTI after the DL slot in which the bit sequence was received (either 302-5 or 303-1 in FIG. 3C). Bit sequence 101 is interpreted that the UE should send its data without CQI in the two designated slots/TTIs (a) and (c), which are the next available UL slot/TTI and the third available UL slot/TTI after the DL slot in which the bit sequence was received (either the pair 302-1 & 302-5 or the pair 302-4 & 303-1 in FIG. 3C). Bit sequence 110 is interpreted that the UE should send its data without CQI in the two designated slots/TTIs (b) and (c), which are the second and third available UL slots/TTIs after the DL slot in which the bit sequence was received (either the pair 302-4 & 302-5 or the pair 302-5 & 303-1 in FIG. 3C).

Finally, FIG. 3D shows yet another variation where the CQI request is eliminated, leaving one of the bit sequences available for indicating the other single TTI allocation [for (b)] which FIG. 3A could not do. This seems to give greater flexibility for TTI scheduling with minimal overhead, but what is not shown at FIG. 3D is that some signaling overhead must be occupied elsewhere in order to signal the UE to send its CQI measurement report. Specifically, at FIG. 3D bit sequences 01, 10 and 11 are each interpreted as was detailed for those same bit sequences at FIG. 3B, and bit sequence 00 is interpreted as bit sequence 011 was detailed for FIG. 3C.

Signaling-wise, the two-bit embodiments detailed above by example at FIGS. 2, 3A, and 3B conveniently combine with an indicator for “scheduled CQI”, of which the latter is required in LTE anyway. Assuming that, apart from the joint coding of these teachings, the scheduled CQI for FDD and UL<DL TDD mode is 1 bit at a minimum, this approach has a cost of only a single bit for the multi-TTI allocation scheme (and even includes the absolute referencing needed when DL<UL). So an embodiment may be concisely described as using two bits to represent/indicate multi-TTI+scheduled CQI information. These multi-TTI indicator bits may be conveniently denoted as a multi-TTI scheduled CQI (MT-SCQI) field in each UL grant.

From the above description it is apparent that embodiments of this invention include an apparatus such as a portable user equipment, a computer program embodied on a memory that may be disposed in the user equipment, and a method by which the user equipment receives from a network element (e.g., an e-NodeB for example) an uplink resource allocation that includes an indicator (e.g., the multi-TTI indicator bits) that in a first case inform the UE to send a measurement report (and of its UL resource grant) and in a second case inform the UE that the resource allocation is for multiple (two or three consecutive) UL resources (PRBs). Thereafter, the UE sends to the network element in the first case data and the requested measurement report on the allocated resource, and in the second case the UE sends to the network element data on the multiple UL resources.

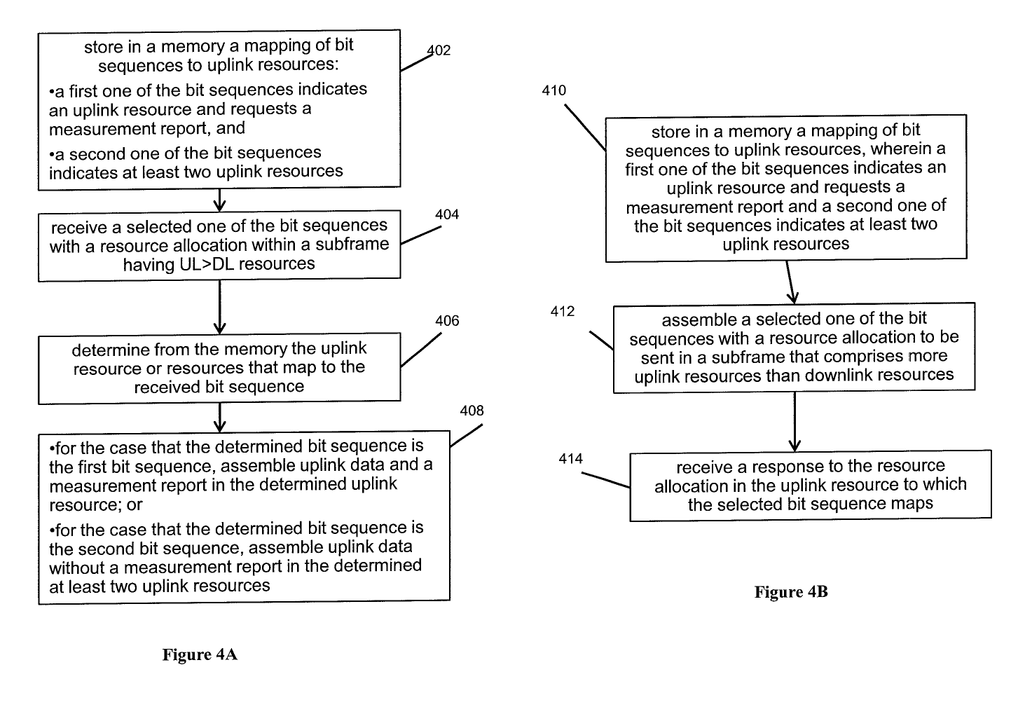

This aspect is shown at FIG. 4A, which is an exemplary process diagram from the perspective of the UE. At block 402 the UE stores in its memory a mapping of bit sequences to uplink resources, wherein a first one of the bit sequences indicates an uplink resource and requests a measurement report and a second one of the bit sequences indicates at least two uplink resources. This is shown by example at bit sequences 00 and 11 of FIG. 2. At block 404 the UE receives one of the bit sequences (term this a selected one) with a resource allocation. This is received in a subframe that comprises more uplink resources than downlink resources. The UE then determines at block 406, from the memory, the uplink resource or resources that map to the received bit sequence. For the case that the determined bit sequence is the first bit sequence, at block 408 the UE assembles its uplink data and a measurement report in the determined uplink resource. For the case that the determined bit sequence is the second bit sequence, then at block 408 the UE assembles its uplink data without a measurement report in the determined at least two uplink resources.

Similarly from the Node B's perspective, embodiments of this invention include an apparatus such as a network element (e.g., an e-Node B for example), a computer program embodied on a memory that may be disposed in the network element, and a method by which the network element sends to a UE an uplink resource allocation that includes an indicator (e.g., the multi-TTI indicator bits) that in a first case request the UE to send a measurement report (and informs the UE of its UL resource grant) and in a second case informs the UE that the resource allocation is for multiple (two or three consecutive) UL resources (PRBs). Thereafter, the network element receives from the UE in the first case data and the requested measurement report on the allocated resource, and in the second case the network element receives from the UE data on the multiple UL resources.

This aspect is shown at FIG. 4B, which is an exemplary process diagram from the perspective of the access node/e-Node B. At block 410 the access node stores in its memory a mapping of bit sequences to uplink resources, wherein a first one of the bit sequences indicates an uplink resource and requests a measurement report and a second one of the bit sequences indicates at least two uplink resources. At block 412 the e-Node B assembles a selected one of the bit sequences with a resource allocation to be sent in a subframe, in which that subframe comprises more uplink resources than downlink resources. And at block 414 the access node receives a response to the resource allocation in the uplink resource to which the selected bit sequence maps.

For the aspects of this invention related to network, embodiments of this invention may be implemented by computer software executable by a data processor of the Node B 12, such as the processor 12A shown, or by hardware, or by a combination of software and hardware. For the aspects of this invention related to user equipment, embodiments of this invention may be implemented by computer software executable by a data processor of the UE 10, such as the processor 10A shown, or by hardware, or by a combination of software and hardware. Further in this regard it should be noted that the various logical step descriptions above may represent program steps, or interconnected logic circuits, blocks and functions, or a combination of program steps and logic circuits, blocks and functions.

In general, the various embodiments may be implemented in hardware or special purpose circuits, software (computer readable instructions embodied on a computer readable medium), logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Although described in the context of particular embodiments, it will be apparent to those skilled in the art that a number of modifications and various changes to these teachings may occur. Thus, while the invention has been particularly shown and described with respect to one or more embodiments thereof, it will be understood by those skilled in the art that certain modifications or changes may be made therein without departing from the scope of the invention as set forth above, or from the scope of the ensuing claims.

1. A method comprising:
storing in a memory a mapping of bit sequences to uplink resources, wherein a first one of the bit sequences indicates an uplink resource and requests a measurement report and a second one of the bit sequences indicates at least two uplink resources;
assembling a selected one of the bit sequences with a resource allocation to be sent in a subframe that comprises more uplink resources than downlink resources; and
receiving a response to the resource allocation in the uplink resource to which the selected bit sequence maps.

2. The method according claim 1, wherein each of the bit sequences are a same length that is either two bits or three bits.

3. The method according to claim 1, wherein one of the bit sequences maps to an uplink resource that is next available after a downlink resource in which the bit sequence is sent, and another of the bit sequences maps to an uplink resource that is second next available after the downlink resource in which the bit sequence is sent.

4. The method according to claim 3, where in one instance for the downlink resource, the uplink resource that is next available comprises a first uplink resource of a next subframe and the uplink resource that is second next available comprises an uplink resource that immediately follows a downlink resource of the next frame.

5. The method according to claim 1, in which a third one of the bit sequences indicates the same uplink resource as the first bit sequence but does not request a measurement report.

6. The method according to claim 5, in which each of the bit sequences are two bits in length and two of the bit sequences each indicates at least two uplink resources.

7. The method according to claim 5, in which each of the bit sequences are three bits in length and at least one of the bit sequences indicates at least three uplink resources.

8. An apparatus comprising:
a memory storing a mapping of bit sequences to uplink resources, wherein a first one of the bit sequences indicates an uplink resource and requests a measurement report and a second one of the bit sequences indicates at least two uplink resources;
a processor configured to assemble a selected one of the bit sequences with a resource allocation to be sent in a subframe that comprises more uplink resources than downlink resources; and
a receiver configured to receive a response to the resource allocation in the uplink resource to which the selected bit sequence maps.

9. The apparatus according claim 8, wherein each of the bit sequences are a same length that is either two bits or three bits.

10. The apparatus according to claim 8, wherein one of the bit sequences maps to an uplink resource that is next available after a downlink resource in which the bit sequence is sent, and another of the bit sequences maps to an uplink resource that is second next available after the downlink resource in which the bit sequence is sent.

11. The apparatus according to claim 10, where in one instance for the downlink resource, the uplink resource that is next available comprises a first uplink resource of a next subframe and the uplink resource that is second next available comprises an uplink resource that immediately follows a downlink resource of the next frame.

12. The apparatus according to claim 8, in which a third one of the bit sequences indicates the same uplink resource as the first bit sequence but does not request a measurement report.

13. The apparatus according to claim 12, in which each of the bit sequences are two bits in length and two of the bit sequences each indicates at least two uplink resources.

14. The apparatus according to claim 12, in which each of the bit sequences are three bits in length and at least one of the bit sequences indicates at least three uplink resources.

15. A memory storing a program of computer readable instructions that when executed by a processor result in actions comprising:
selecting a bit sequence from a storage medium that stores a mapping of bit sequences to uplink resources, wherein a first one of the bit sequences indicates an uplink resource and requests a measurement report and a second one of the bit sequences indicates at least two uplink resources; and
assembling the selected bit sequence with a resource allocation to be sent in a subframe that comprises more uplink resources than downlink resources.

16. The memory according to claim 15,
wherein each of the bit sequences are a same length that is either two bits or three bits; and
wherein one of the bit sequences maps to an uplink resource that is next available after a downlink resource in which the bit sequence is sent, another of the bit sequences maps to an uplink resource that is second next available after the downlink resource in which the bit sequence is sent, and still another of the bit sequences indicates the same uplink resource as the first bit sequence but does not request a measurement report.

17. A method comprising:
storing in a memory a mapping of bit sequences to uplink resources, wherein a first one of the bit sequences indicates an uplink resource and requests a measurement report and a second one of the bit sequences indicates at least two uplink resources;
receiving, in a subframe that comprises more uplink resources than downlink resources, a selected one of the bit sequences with a resource allocation;
determining from the memory the uplink resource or resources that map to the received bit sequence; and
assembling uplink data and a measurement report in the determined uplink resource for the case that the determined bit sequence is the first bit sequence, or assembling uplink data without a measurement report in the determined at least two uplink resources for the case that the determined bit sequence is the second bit sequence.

18. The method of claim 17,
wherein each of the bit sequences are a same length that is either two bits or three bits; and
wherein one of the bit sequences maps to an uplink resource that is next available after a downlink resource in which the bit sequence is sent, another of the bit sequences maps to an uplink resource that is second next available after the downlink resource in which the bit sequence is sent, and still another of the bit sequences indicates the same uplink resource as the first bit sequence but does not request a measurement report.

19. An apparatus comprising:
a memory storing a mapping of bit sequences to uplink resources, wherein a first one of the bit sequences indicates an uplink resource and requests a measurement report and a second one of the bit sequences indicates at least two uplink resources;
a receiver configured to receive, in a subframe that comprises more uplink resources than downlink resources, a selected one of the bit sequences with a resource allocation; and
a processor configured to determine from the memory the uplink resource or resources that map to the received bit sequence, and to assemble data and a measurement report in the determined uplink resource for the case that the determined bit sequence is the first bit sequence, or to assemble data without a measurement report in the determined at least two uplink resources for the case that the determined bit sequence is the second bit sequence.

20. The apparatus of claim 19,
wherein each of the bit sequences are a same length that is either two bits or three bits; and
wherein one of the bit sequences maps to an uplink resource that is next available after a downlink resource in which the bit sequence is sent, another of the bit sequences maps to an uplink resource that is second next available after the downlink resource in which the bit sequence is sent, and still another of the bit sequences indicates the same uplink resource as the first bit sequence but does not request a measurement report.
